(19) United States
(12) Patent Application Publication
(10) Pub. No.: US 2003/0097246 A1
(43) Pub. Date: May 22, 2003

(54) Circuit simulation method

(76) Inventors: Tsutomu Hara, Fujisawa (JP); Hideki Osaka, Oiso (JP); Toyohiko Komatsu, Yokohama (JP); Hitoshi Yokota, Kawasaki (JP); Atsushi Nakamura, Fuchu (JP); Koichi Kimura, Kamakura (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/987,841

(22) Filed: Nov. 16, 2001

(51) Int. Cl. G06F 17/50

(52) U.S. Cl. 703/14

(57) ABSTRACT

In a circuit simulation system, a simulator and part of device models and circuit models are stored in a server on the Internet, a user sends arbitrary circuit data to the server, the server carries out calculation using the circuit data received from the user and the device and circuit models stored therein, and then the server returns the results of calculation to the user.

### BACKGROUND OF THE INVENTION

1. Field of the Invention

The present invention relates to a circuit simulation method for carrying out operational simulations of electronic circuits to be contained in electronic products, and more particularly to a circuit simulation technique using a network. Furthermore, the invention pertains to a technique for designing and manufacturing electronic products including electronic circuits, not limited to simulation testing.

2. Description of the Related Art

Conventional simulation techniques are described below as related to electronic circuits. High-level expertise in semiconductor device technology and electromagnetics is required for designing high-frequency digital circuits to be used in personal computers/workstations and analog electronic circuits to be used in radio communication equipment. In circuit design, it is particularly difficult to make accurate predictions on device behavior and propagation delay due to dielectrics or reflection/crosstalk on transmission lines. Conventionally, a circuit simulator such as SPICE (Simulation Program with Integrated Circuit Emphasis: L. W. Nagel, SPICE 2, A Computer Program to Simulate Semiconductor Circuits, Electronics Research Laboratory, Rep. No. ERL-M520, University of California, Berkeley, 1975) is employed as a computer-aided design tool to analyze electromagnetic propagation behavior on circuits for realizing optimum circuit design.

In common practice of analyzing digital-circuit transmission lines using SPICE, each chip-set manufacturer individually builds up a simulation environment and a database containing device models, circuit connection models and noise budgets for preparing assembly specifications. IC and LSI device models to be used for circuit simulation, except general-purpose IC device models, are supplied by device manufacturers in most cases. Therefore, it is sometimes difficult for other than device manufactures to carry out circuit simulation.

In circuit simulation using SPICE, device models supplied by device manufacturers are roughly classified into two kinds of models; IBIS models (input/output buffer information specification models) describing LSI behavior in terms of voltage-current relationship, and transistor models describing LSI behavior at transistor level. Although transistor models are highly accurate models, there is a possibility that confidential technical information on internal circuits and fabrication processes of devices may leak out since operations of individual transistors are described in detail.

To prevent leakage of confidential technical information such as noted above, an individual confidentiality agreement is commonly made between a chip-set manufacturer and a device manufacturer when the device manufacturer supplies transistor models to the chip-set manufacturer. In contrast, IBIS models are advantageous in that confidential technical information on internal circuits and fabrication processes of LSIs can be concealed securely since LSI behavior is described in terms of voltage-current relationship. However, in an application to simulation of a circuit where an impedance thereof varies dynamically, IBIS models cannot provide satisfactory accuracy in calculation. As mentioned above, in cases where transistor models, which are highly accurate models, are used for circuit simulation, there is a possibility of leakage of confidential technical information and it is therefore required to establish a confidentiality agreement for preventing leakage thereof. In cases where IBIS models, which are simplified models, are used for circuit simulation, there is difficulty in attaining satisfactory accuracy in calculation.

Furthermore, for transmission line modeling in simulation of a high-speed circuit, preliminary experiment-based verification and know-how are required to check the validity of model elements. A substantial amount of time and accumulated experience are therefore needed to prepare a transmission line model through proper prediction.

### SUMMARY OF THE INVENTION

It is an object of the present invention to provide a circuit simulation method for SPICE device modeling, in which leakage of confidential technical information on internal circuits and fabrication processes of devices can be prevented while supplying results of high-accuracy simulation model calculation.

Another object of the present invention is to provide a circuit simulation method wherein transmission line modeling, which conventionally necessitates accumulation of know-how and experiment-based verification, can be made with ease for simulation while preventing leakage of confidential technical information on circuit model structures to a third party.

In accomplishing these objects of the present invention and according to one aspect thereof, there is provided a circuit simulation method wherein a simulator and part of device models and circuit models are stored in a networked server, wherein a user requesting execution of a circuit simulation sends arbitrary circuit data from a client terminal of the user to the server, and wherein the server performs calculation using the circuit data received from the client terminal and the device and circuit models stored in the server, and then the server returns the results of the calculation to the user. Any networked client terminal other than the client terminal which has sent the circuit data to the server may be used for receiving the calculation results, or any networked client terminal for receiving the calculation results may be specified by the client terminal which has sent the circuit data to the server.

The above and other objects, features and advantages of the present invention will become more apparent from the following detailed description with reference to the accompanying drawings.

### BRIEF DESCRIPTION OF THE DRAWINGS

FIG. 1 is a schematic diagram showing a system configuration in a first preferred embodiment of the present invention;

FIG. 2 is a flowchart showing system operations in the first preferred embodiment of the present invention;

FIG. 3 is a diagram showing an example of an entry screen;

FIG. 4 is a diagram showing an example of user registration;

FIG. 5 is a diagram showing an example of a circuit parameter input screen;

FIG. 6 is a diagram showing an example of a calculation status screen;

FIG. 7 is a diagram showing an example of a calculation result screen displayed in the course of calculation;

FIG. 8 is a diagram showing an example of a calculation result screen displayed at the end of calculation;

FIG. 9 is a schematic diagram showing a conventional system configuration;

FIG. 10 is a diagram showing a design flow at a chip-set manufacturer (circuit design engineering party);

FIG. 11 is a diagram showing a model producing flow at a model supplier;

FIG. 12 is a schematic diagram showing a system configuration in a second preferred embodiment of the present invention;

FIG. 13 is a flowchart showing system operations in the second preferred embodiment of the present invention; and

FIG. 14 is a diagram showing an example of a calculation result and device information screen.

### DETAILED DESCRIPTION OF THE PREFERRED EMBODIMENTS

The present invention will now be described in detail by way of example with reference to the accompanying drawings.

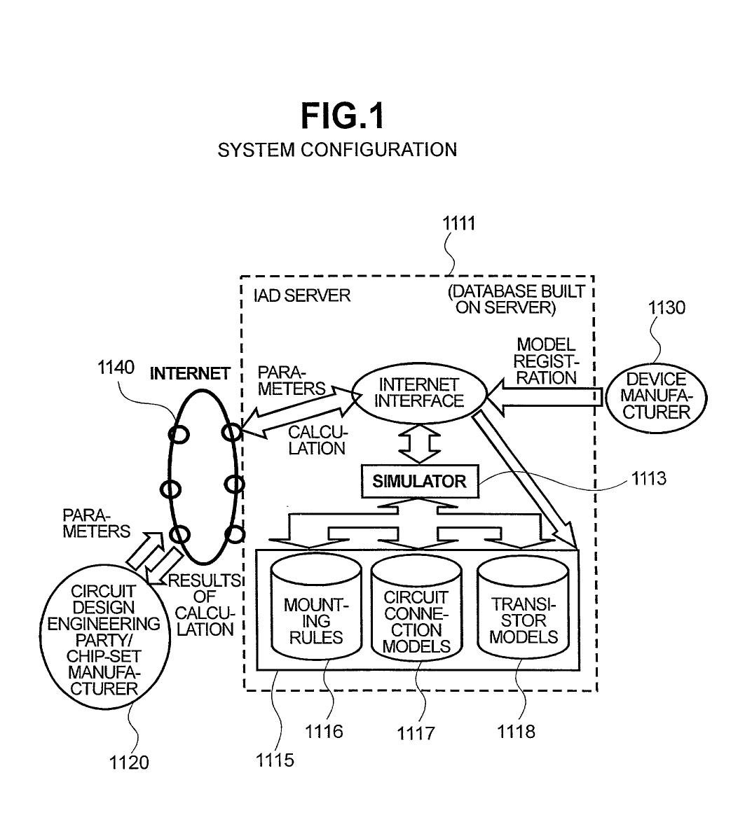

The following describes a first preferred embodiment of the present invention. Referring to FIG. 1, there is shown a configuration of a circuit simulation system in the first preferred embodiment. The circuit simulation system of the first preferred embodiment mainly comprises a terminal apparatus 1120 of a circuit design engineering party (chip-set manufacturer), a terminal or server 1130 of a device manufacturer, and a server 1111 in which circuit simulation is carried out. The server 1111 is connected to the terminal apparatus 1120 of the circuit design engineering party (chip-set manufacturer) over the Internet 1140.

The server 1111 is also connected to the Internet 1140 and to the terminal 1130 of the device manufacturer through an Internet interface 1112. Note that the server 1111 may be connected to the terminal 1130 of the device manufacturer via the Internet 1140, a local area network, or a part of the server 1111 itself. On the server 1111, there is provided a data region 1115 in which data necessary for circuit simulation is stored.

The data region 1115 comprises a region 1116 for holding design rules such as noise budgets, a region 1117 for holding simulation circuit connection models, and a region 1118 for holding device transistor models. These regions can be accessed by the device manufacturer.

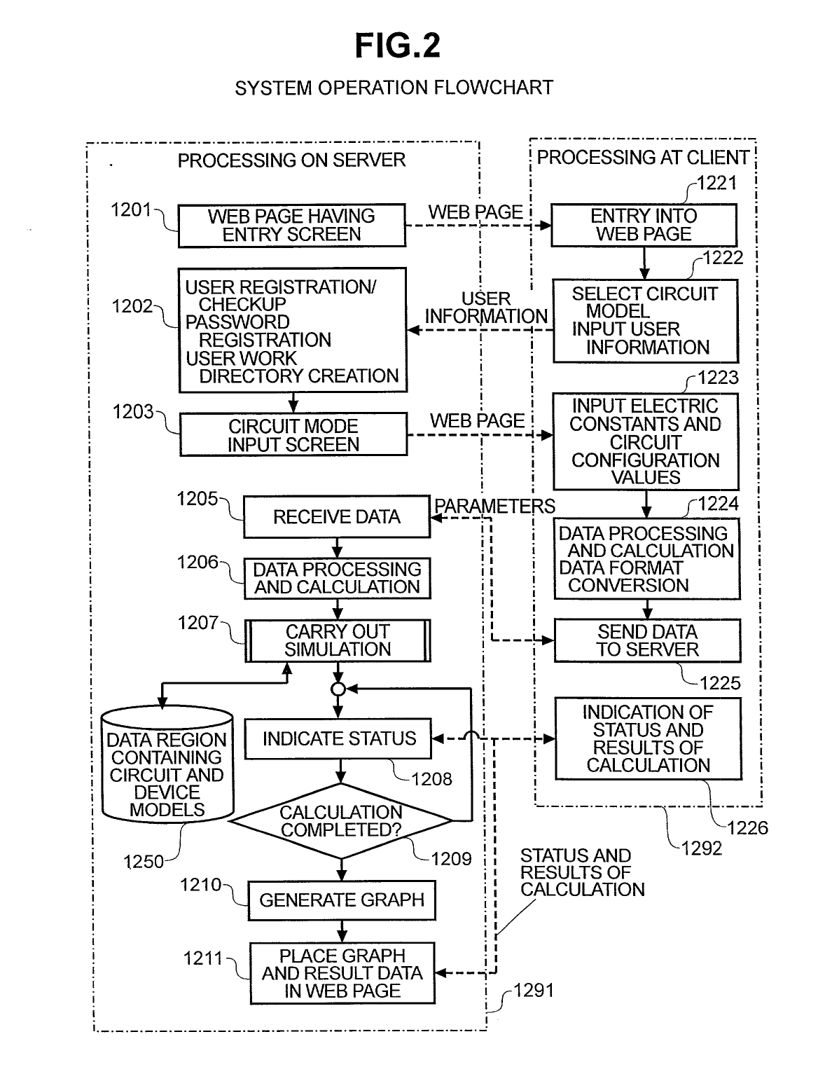

With reference to FIGS. 2 to 9, a data processing flow in the first preferred embodiment is described below.

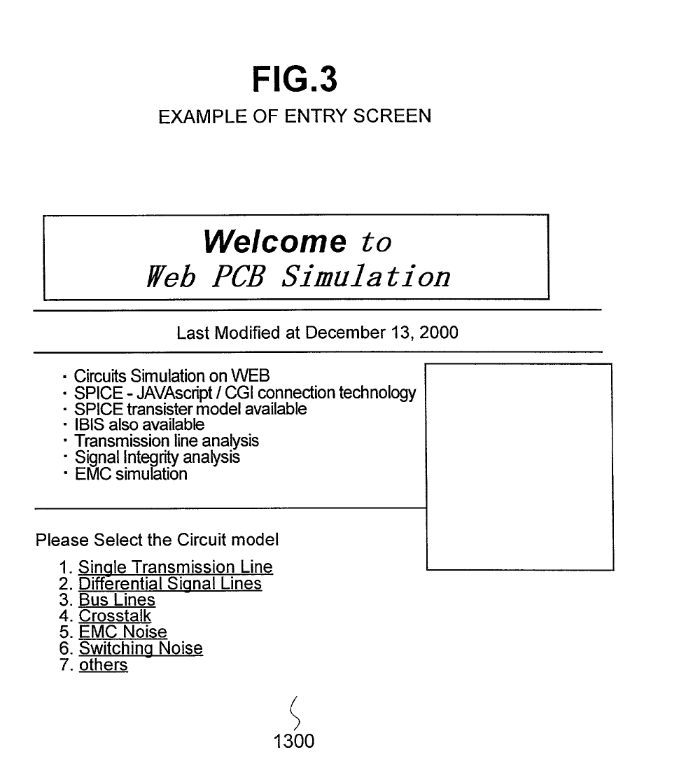

FIG. 2 shows a flow of data processing in the circuit simulation system. In processing 1291 on the server 1111 shown in FIG. 2, a Web page (home page) having an entry screen 1300 such as shown in FIG. 3 is set up on the Internet. The circuit design engineering party 1120 (chip-set manufacturer using the terminal apparatus 1120) can enter the environment of the circuit simulation system by accessing the Web page 1130 on the Internet.

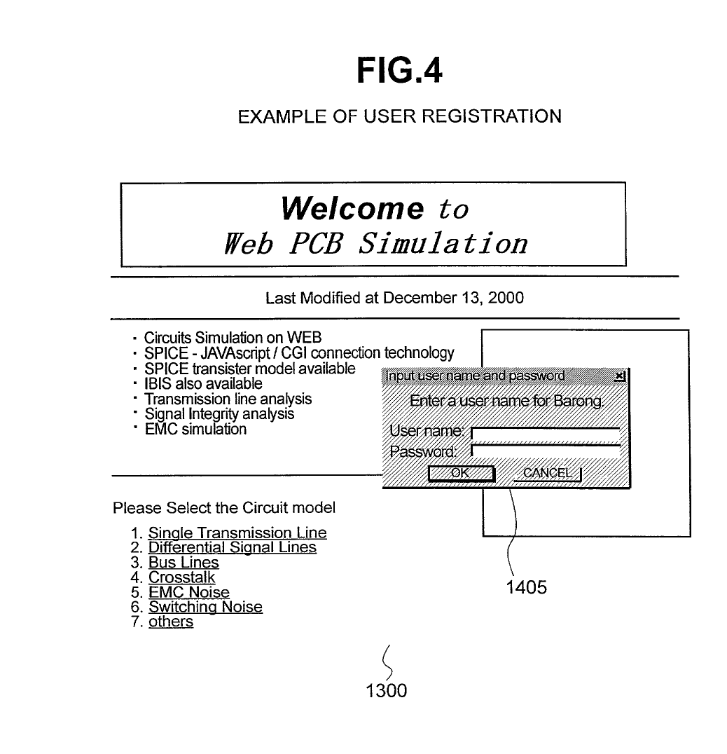

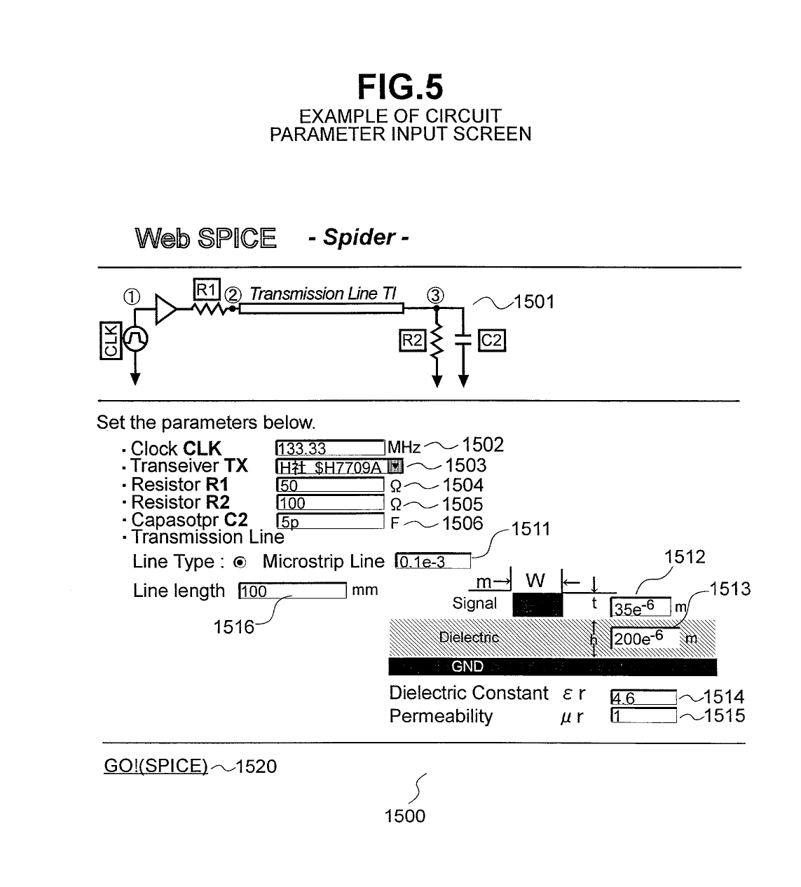

When the circuit design engineering party (chip-set manufacturer) 1120 selects a desired circuit model, the circuit design engineering party inputs a user account (user name) and a password as shown in FIG. 4. Thus, information on circuit model selection (destination-of-link information) is sent to the server 1111 (processing 1291 on the server) together with the user account and password. The user account and password are used for billing and checking an attempt to access simulation result data or calculation graph data. Upon receiving the circuit model selection information (destination-of-link information), user account and password, the server 1111 performs a user registration/checkup and then presents a Web page 1500 shown in FIG. 5 according to the circuit model selection information (destination-of-link information). On the Web page 1500, the circuit design engineering party can specify such parameters as circuit configuration values, electric constants and driver elements.

As shown in FIG. 5, the circuit design engineering party enters electric constants with reference to a circuit model scheme 1501. A first input box 1502 is used for specifying an operation frequency. A second input box 1503 has a pull-down menu, which provides a list of selectable device names. The following three input boxes 1504 to 1506 are used for specifying a damping resistance, a terminator resistance, and a load capacity of a receiver.

On the lower part of the Web page 1500, there are provided input boxes for defining a cross-sectional configuration of a circuit board. These input boxes are used to specify a line width 1511, a line thickness 1512, a dielectric layer thickness 1513, a dielectric constant 1514, a permeability value 1515, and a line length 1516. Calculation is performed to determine a constant according to the printed circuit board configuration and signal wiring arrangement concerned. After entering all the conditions, the circuit design engineering party presses a calculation run button 1510 to issue a calculation execution command. When the calculation execution command is issued, an impedance and a propagation velocity are calculated and data reshaping for transmission thereof is carried out at the terminal apparatus of the circuit design engineering party (data processing and calculation 1224 in FIG. 2).

Thereafter, data thus prepared at the terminal apparatus of the circuit design engineering party is sent to the server (1225 in FIG. 2). The server receives the data over the Internet (1205 in FIG. 2), and then carries out data processing and calculation for circuit simulation (1206 in FIG. 2). After these steps, a SPICE simulation start command is issued to the server to carry out SPICE circuit simulation (1207 in FIG. 2).

In execution of the SPICE circuit simulation, calculation is performed using the above-noted data including the electric constants, device name and circuit configuration values which have been input through the Internet, with reference to mounting rule data, circuit connection model data and transistor model data stored in the data region 1115 of the server. Simultaneously with execution of the circuit simulation, a status display screen is prepared to indicate the progress of calculation (1208 in FIG. 2).

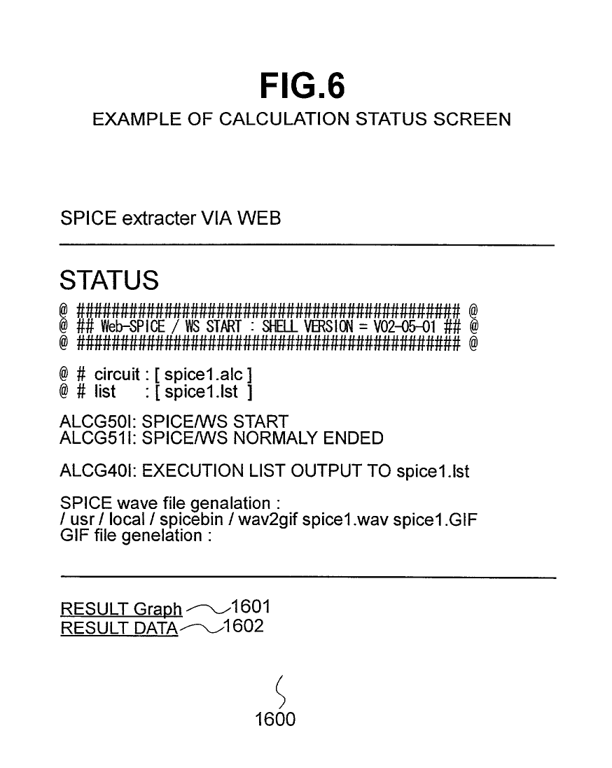

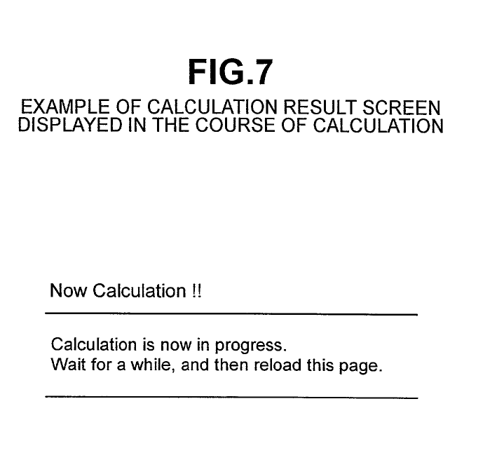

FIGS. 6 and 7 show examples of status display screens. In the first preferred embodiment of the present invention, when the calculation run button (1510 in FIG. 3) is pressed, the status display screen shown in FIG. 6 is presented to indicate whether or not calculation has been performed normally. When a calculation result display button 1601 is pressed in the course of calculation, the status display screen shown in FIG. 7 is presented. A judgment is formed on whether or not the circuit simulation has been completed. If not, a wait is provided until completion of the circuit simulation (1209 in FIG. 2). At the end of execution of the circuit simulation, a graph is generated using the results of the circuit simulation (1210 in FIG. 2).

Then, the graph thus generated and numeric data resultant from the circuit simulation are processed for placement in a Web page (1211 in FIG. 2). At this step, the status display screen shown in FIG. 7 (Web page 1701) is changed into a graph display page. Thus, the calculation result display button 1601 can be used for checking the current status of calculation and the results of calculation. In this arrangement, since the circuit design engineering party (chip-set manufacturer) can disconnect the terminal apparatus thereof from the circuit simulation system during a calculation time, the circuit design engineering party can perform another task on the terminal apparatus without applying unnecessary load thereto.

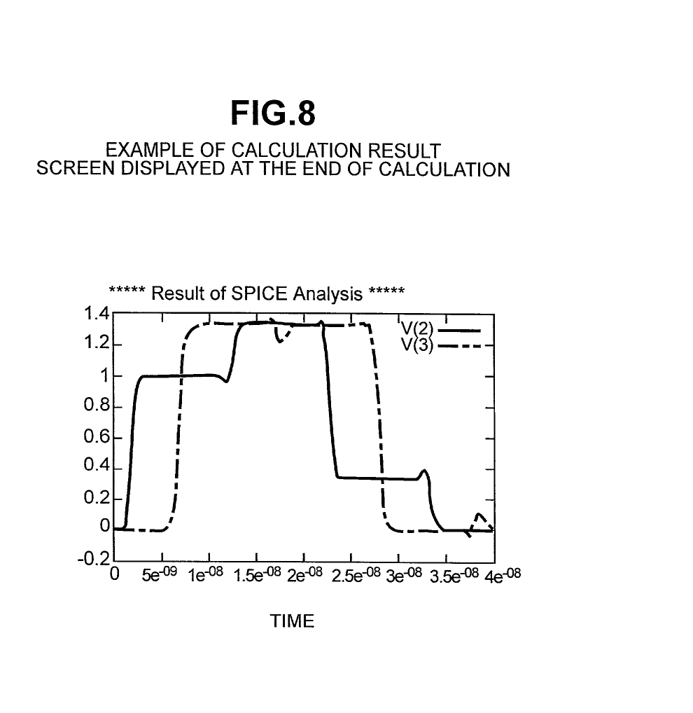

Further, by making access to the Internet at a convenient time, the circuit design engineering party can acquire a calculation result graph such as shown in FIG. 8 and numeric data through the status display screen shown in FIG. 6. When the circuit design engineering party attempts to access calculation result data, a message prompting for input of a user account (name) and a password appears as shown in FIG. 4. This makes it possible for the circuit design engineering party to attain calculation result data concerned promptly while preventing a third party from reading the calculation result data.

The advantageous effects of the first preferred embodiment of the present invention are described below with reference to FIGS. 1, 2, and 9 to 11.

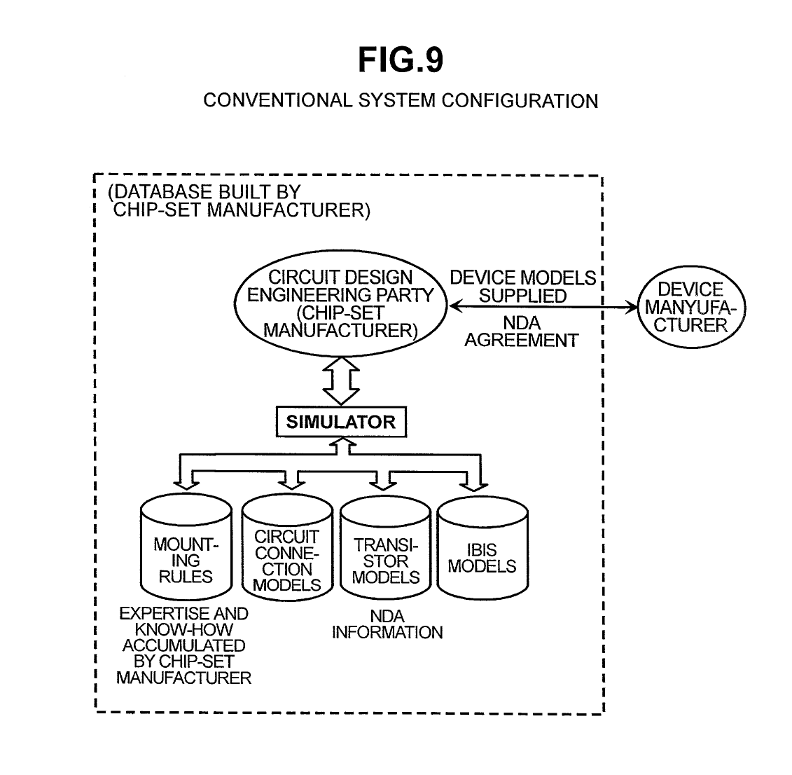

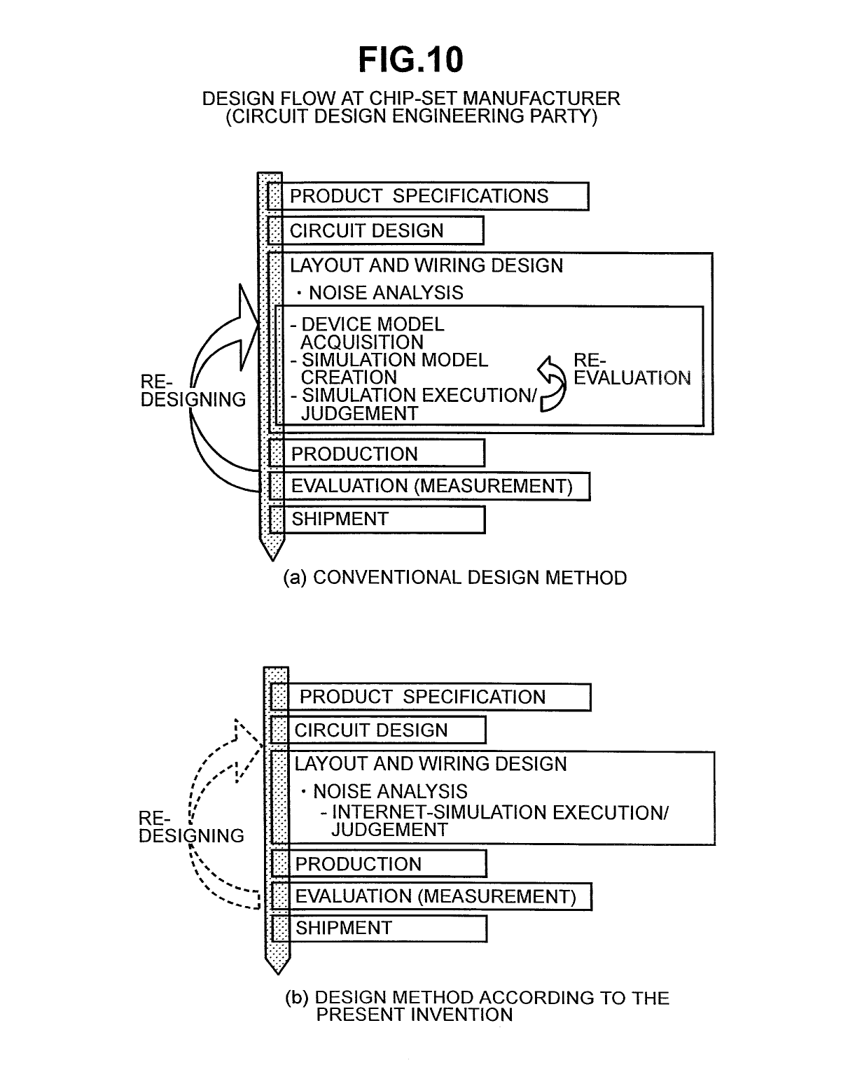

Using FIGS. 9, 10 and 1, the advantageous effects of the first preferred embodiment from the standpoint of the circuit design engineering party are discussed first. FIG. 9 shows a conventional design method using circuit simulation. In the conventional design method, there is provided a simulator 1920 on the part of a circuit design engineering party (chip-set manufacturer) 1221 as shown in FIG. 9. Mounting rules 1916 and circuit connection models 1917 are also formed on the part of the circuit design engineering party 1221. That is to say, it is required for the circuit design engineering party to prepare a simulator, mounting rules, circuit connection models, and device simulation models. Therefore, a mounting design flow such as shown in FIG. 10(a) is taken on the part of the circuit design engineering party. In the conventional design method, product specifications are determined first, and then digital circuit logic design is performed. Thereafter, mounting design for layout and wiring arrangements is carried out. In the phase of mounting design, circuit simulation is performed to check for reflection due to circuit impedance mismatching, transmission line propagation delay, crosstalk, radiation noise, etc.

Based on the results of model optimization examination and circuit simulation, the designing of layout and wiring arrangements is repeated to attain a proper mounting formation. Then, an actual circuit board is produced and evaluated. If any specified requirement is not satisfied, mounting design and circuit simulation are repeated until the specified requirement is satisfied. For shortening a design time, it is required to optimize simulation models. Further, it is also required to reduce the number of repetitions of layout/wiring design based on the results of circuit simulation and mounting design based on the results of actual product evaluation. Therefore, in mounting design of high-speed circuits, accumulation of know-how and verification through experiments are needed for preparing proper mounting rules 1916 and circuit connection models 1917.

Moreover, in the conventional design method, the circuit design engineering party 1221 is required to prepare device transistor models 1918. In cases where high-accuracy simulation calculation is carried out using the device transistor models 1918, actual LSI process data and transistor characteristics must be expressed with high fidelity. Through model analysis on the part of the circuit design engineering party 1221, there is a possibility that confidential technical information and know-how possessed by the device manufacturer concerned 1130 may leak to the circuit design engineering party 1121.

To prevent leakage of confidential technical information out of the device transistor models 1918, a confidentiality agreement is made between the circuit design engineering party 1221 and the device manufacturer 1130 at much expense in time and effort. As a means of preventing leakage of confidential technical information, IBIS models 1919 (input/output buffer information specification models) for approximately expressing LSI behavior in terms of voltage-current relationship are used in some cases. The IBIS models 1919 are however disadvantageous in that satisfactory calculation accuracy is not attainable.

By way of contrast, in the first preferred embodiment of the present invention, the transistor models 1118 are managed in the server. Therefore, the circuit design engineering party (chip-set manufacturer) cannot make direct access to the transistor models 1118.

With reference FIG. 2, a flow of data to be used by the circuit design engineering party is described below. In FIG. 2, each broken line indicates a path through which information is disclosed. From the server, the circuit design engineering party receives the following data; table-of-contents screen data 1201 (FIG. 3), user registration screen data 1202 (FIG. 4), circuit model screen data 1203 (FIG. 5), calculation status screen data 1208 (FIG. 6), and calculation result screen data 1211 (FIG. 8). In the circuit simulation system of the present invention, since transistor model data is not directly disclosed to the circuit design engineering party but calculation result data only is disclosed thereto, it is possible to prevent the circuit design engineering party from attempting unauthorized analysis of device transistor models.

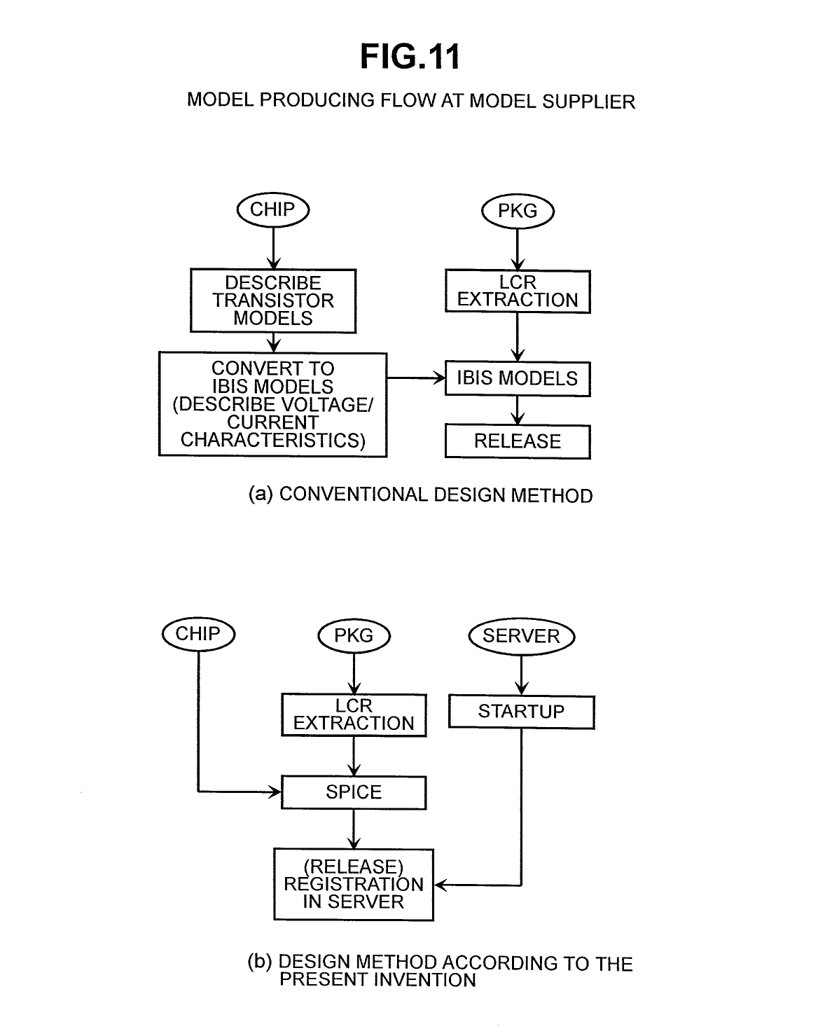

The following describes advantageous effects of the first preferred embodiment from the standpoint of the supply side of device models, with reference to FIGS. 11 and 1. FIG. 11(a) shows how device models are produced by a device model supplier in the conventional design method. Using semiconductor chip process data, transistor models are prepared. At the same time, IBIS modeling is made through analysis of electrical characteristics such as resistance, capacity and inductance of each LSI package. In this modeling step, for reproducing actual operation with high fidelity, highly accurate process data is incorporated in simulation models. As a result, there occurs a possibility that confidential technical information regarding fabrication process, circuit design and manufacture may leak out of the simulation models. Therefore, in a situation where simulation models at this step are supplied from the device model supplier to each customer, a confidentiality agreement concerning information release is made therebetween. To prevent leakage of confidential technical information out of simulation models, transistor models are converted into IBIS models in which device output is approximately expressed in terms of voltage-current relationship.

For preparing each of these IBIS models, it is required to take a burdensome step of determining a voltage-current relational condition through experiments. A circuit scheme in which an impedance varies during operation is adopted for a certain type of high-speed circuit. In such a case, it is necessary to prepare each model corresponding to each condition. Thus, time-consuming tasks for experiments and conditioning are needed to produce simplified models.

Further, as shown in FIG. 9, each circuit design engineering party (chip-set manufacturer) uses a simulator of its own. In some cases, simulation models may not be applicable to a type/version of simulator different from that assumed by the device manufacturer. To circumvent this problem, the device manufacturer must prepare models applicable to each type/version of simulator at much expense in time and effort. Further, a substantial amount of time and additional costs are required in cases where models thus prepared are delivered to many customers.

In the first preferred embodiment of the present invention, since there is no need to disclose device transistor model data to each customer as mentioned in the foregoing, the device manufacturer has only to register, in the server, combination models containing device transistor models and electric constant models of LSI packages as shown in FIG. 11(b). It is therefore not required to prepare approximate models and carry out experiments using these models. Further, since models are registered only in the server regardless of the number of customers, the time and costs required for delivering models to each customer can be eliminated.

Moreover, the server may also be provided with a model access counting function and a device usage recording function. Through the use of these functions, the device manufacturer can attain information on technical trends in circuit modeling among the customers.

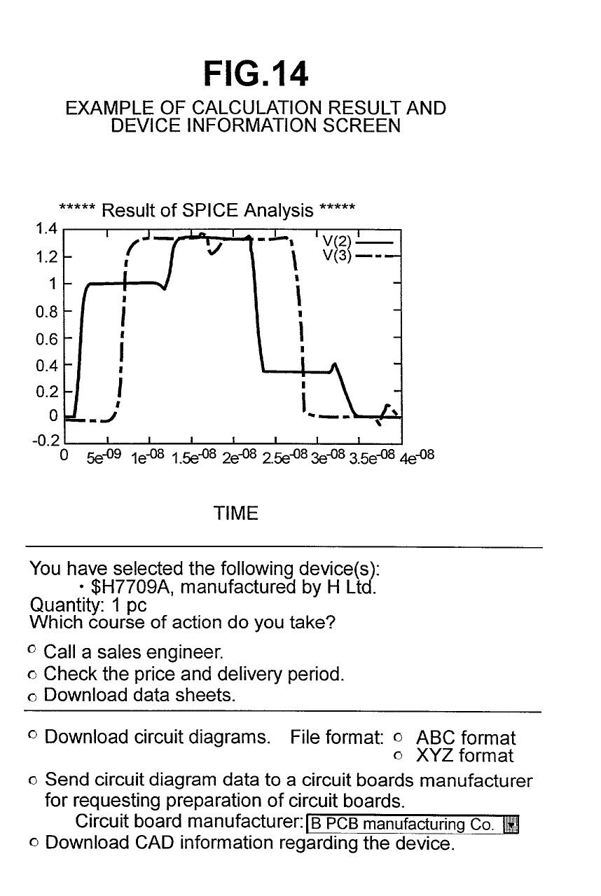

Still further, as shown in FIG. 14, a screen for displaying the results of calculation in circuit simulation may be so arranged as to indicate such items as selected device data, device configuration data, a request for data sheets/circuit diagrams used for calculation, and a purchase order for devices. This makes it easy for each customer to place an order for devices, which could lead to an increase in sales of the devices.

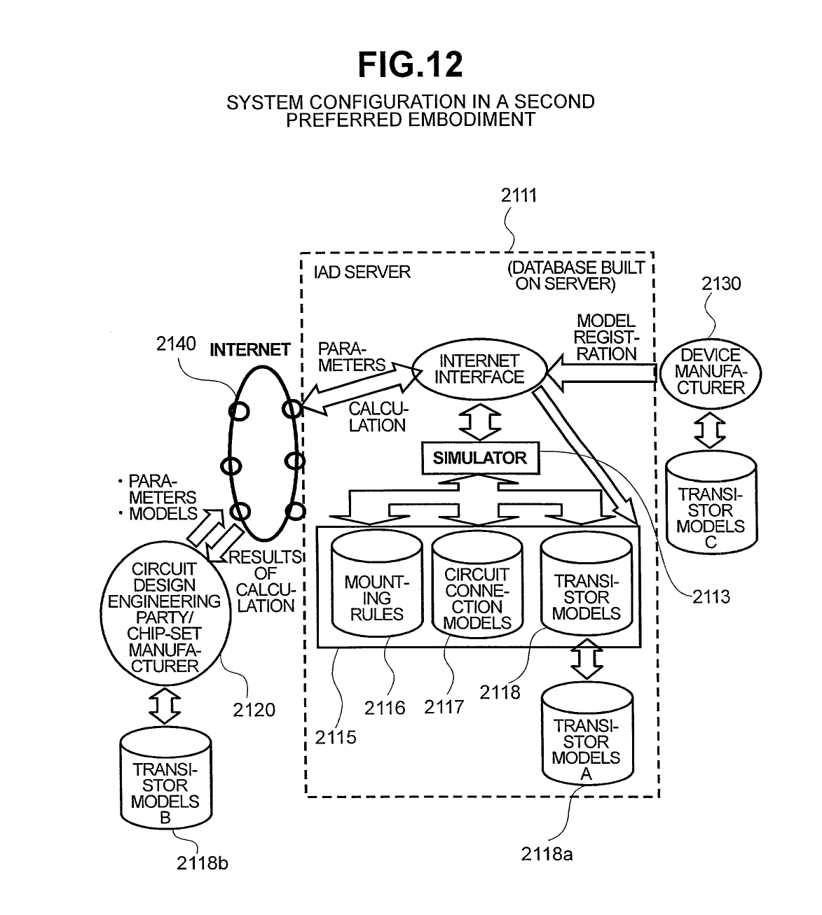

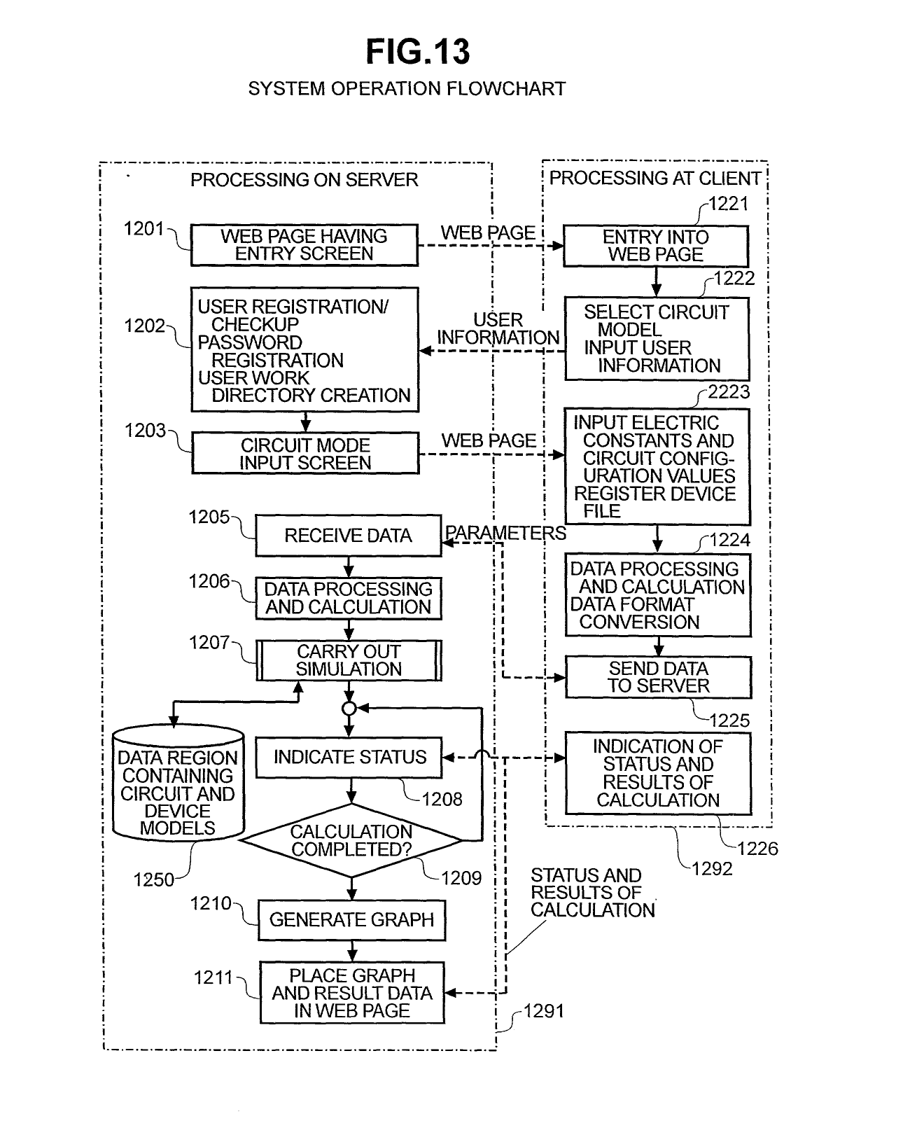

The following describes a circuit simulation system according to a second preferred embodiment of the present invention, with reference to FIGS. 12 and 13. As in the first preferred embodiment, the circuit simulation system of the second preferred embodiment mainly comprises a terminal apparatus 2120 of a circuit design engineering party (chip-set manufacturer), a terminal or server 2130 of a device manufacturer, and server 2111 in which circuit simulation is carried out. The server 2111 is connected to the terminal apparatus 2120 of the circuit design engineering party (chip-set manufacturer) over the Internet 2120. Through an Internet interface 2112, the server 2111 is also connected to the Internet 2140 and to the terminal 2130 of the device manufacturer.

On the server 2111, there is provided a data region 2115 in which data necessary for circuit simulation is stored. The data region 2115 comprises a region 2116 for holding mounting rules such as noise budgets, a region 2117 for holding simulation circuit connection models, and region 2118 for holding device transistor models and device models received from the circuit design engineering party. A manager of the server is authorized to alter the contents of the region 2116 for holding mounting rules such as noise budgets and the region 2117 for holding simulation circuit connection models. The authority to alter the contents of these regions may be granted to either the server manager or a program which carries out data processing in the server. As to device models, a device supplier is authorized to alter device model data. The authority to alter device model data may be granted to either the device supplier or an apparatus (program) managed by the device supplier.

The authority to alter the contents of the region 2118 for holding device models received from the circuit design engineering party is granted to the circuit design engineering party. As mentioned above, the data storage regions in the server are classified into regions accessible only with particular authority and regions accessible without any authority. A simulator used for carrying out circuit simulation can make access to any data in the server.

With reference to FIG. 13, a data processing flow in the second preferred embodiment is described below. FIG. 13 shows a flow of data processing in the circuit simulation system. In processing 1291 on the server shown in FIG. 13, a Web page (home page) having an entry screen 2300 is set up on the Internet. When the circuit design engineering party 2120 (chip-set manufacturer using the terminal apparatus 2120) selects a desired circuit model, the circuit design engineering party inputs a user account (user name) and a password as shown in FIG. 4. Then, information on circuit model selection (destination-of-link information) is sent to the server 2111 (processing 2291 on the server) together with the user account and password. The user account and password are used for billing, checking an attempt to access simulation result data or calculation graph data, and identifying each data region in which user's simulation models are registered. Upon receiving the circuit model selection information (destination-of-link information), user account and password, the server 2111 performs a user registration/checkup and then presents a Web page 2500 according to the circuit model selection information (destination-of-link information). On the Web page 2500, the circuit design engineering party can specify such parameters as circuit configuration values, electric constants and driver elements.

As in the first preferred embodiment, the circuit design engineering party enters electric constants and other parameters with reference to a circuit model scheme. If a unique simulation model is required, the circuit design engineering party specifies a data file therefor. After entering all the conditions, the circuit design engineering party presses a calculation run button 2510 to issue a calculation execution command. When the calculation execution command is issued, an impedance and a propagation velocity are calculated and data reshaping for transmission thereof is carried out at the terminal apparatus of the circuit design engineering party. Thereafter, data regarding electric constants and other parameters for device model selection and data specific to user simulation modeling are sent to the server (1225 in FIG. 13). The server receives these data over the Internet (2205 in FIG. 13), and then carries out data processing and calculation for circuit simulation (2206 in FIG. 13).

According to the user account (user name) and password registered by the circuit design engineering party, simulation model data is stored in the data region of the server. The data region is so arranged as to be accessible by the user (circuit design engineering party), simulator, and server manager. In a modified arrangement, only the server manager may be authorized to access the data region. After these steps, a SPICE simulation start command is issued to the server to carry out SPICE circuit simulation (2207 in FIG. 13). In execution of the SPICE circuit simulation, calculation is performed using the above-noted data including the electric constants, device name and circuit configuration values which have been input through the Internet, with reference to mounting rule data, circuit connection model data, circuit connection model data and user-specific simulation model data stored in the data region 2115 of the server. Simultaneously with execution of the circuit simulation, a status display screen is prepared to indicate the progress of calculation (2208 in FIG. 13).

Then, a judgment is formed on whether or not the circuit simulation has been completed. If not, a wait is provided until completion of the circuit simulation (2209 in FIG. 13). At the end of execution of the circuit simulation, a graph is generated using the results of the circuit simulation (2210 in FIG. 13). Then, the graph thus generated and numeric data resultant from the circuit simulation are processed for placement in a Web page, and the contents of the Web page are registered in a file (2211 in FIG. 13). Thus, the circuit design engineering party can acquire a calculation result graph and numeric data by making access to the Internet at a convenient time.

As mentioned above, in the second preferred embodiment of the present invention, since user-specific simulation model data is temporarily stored in the server, it is possible to perform simulation calculation on other than existent model data pre-registered in the server. Further, a user account (user name) and password are attached to user-specific simulation model data in the server for limiting accessibility thereto. Thus, the user-specific simulation model data can be protected against unauthorized access from a third party.

As set forth hereinabove and according to the present invention, a simulator, device model data and circuit connection model data are registered in a server on the Internet, and a circuit design engineering party (chip-set manufacturer) acquires the results of simulation calculation through the Internet. Thus, only the results of simulation calculation can be disclosed to the circuit design engineering party without directly disclosing device transistor model data thereto. It is therefore possible to prevent the circuit design engineering party from attempting unauthorized analysis of device transistor models. Furthermore, since device models registered in the server are available to the circuit design engineering party through the Internet, there is no need to deliver device models to the circuit design engineering party each time they are updated. In a modification of the present invention, there may be provided such an arrangement that the results of simulation calculation can be accessed only by the circuit design engineering party concerned or from an information processing apparatus used by the circuit design engineering party concerned.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A circuit simulation method for carrying out operational simulation of an electronic circuit through a network, said circuit simulation method comprising the steps of:
sending, from a first information processing apparatus connected with said network, circuit data indicating characteristics of said electronic circuit through said network;
receiving said circuit data at a second information processing apparatus connected with said network, said second information processing apparatus being so arranged that circuit models describing electronic circuit operations are stored to enable operational simulation thereon;
carrying out operational simulation of said electronic circuit at said second information processing apparatus using said circuit models and said circuit data; and
sending results of said operational simulation from said second information processing apparatus through said network.

2. A circuit simulation method as claimed in claim 1,
wherein, at said step of sending results of said operational simulation, said results of said operational simulation are sent to said first information processing apparatus from said second information processing apparatus through said network.

3. A circuit simulation method as claimed in claim 1,
wherein each of said circuit models includes device models, each indicating operations of a device constituting a circuit.

4. A circuit simulation method as claimed in claim 3,
wherein each of said device models includes transistor models, each indicating operations of a transistor constituting said circuit.

5. A circuit simulation apparatus for carrying out operational simulation of an electronic circuit through a network, said circuit simulation apparatus comprising:
means for receiving, from a first information processing apparatus connected with said network, circuit data indicating characteristics of said electronic circuit through said network;
means for storing circuit models describing electronic circuit operations;
means for carrying out operational simulation of said electronic circuit using said circuit models and said circuit data; and
means for sending results of said operational simulation through said network.

6. A circuit simulation apparatus as claimed in claim 5,
wherein said means for sending results of said operational simulation sends said results of said operational simulation to said first information processing apparatus through said network.

7. A circuit simulation apparatus as claimed in claim 5,
wherein each of said circuit models includes device models, each indicating operations of a device constituting a circuit.

8. A circuit simulation apparatus as claimed in claim 7,
wherein each of said device models includes transistor models, each indicating operations of a transistor constituting said circuit.

9. A computer program product storable on a storage medium for carrying out operational simulation of an electronic circuit through a network in a circuit simulation system where said computer program product is run on a computer in which circuit models describing electronic circuit operations are stored, said computer program product comprising the steps of:
receiving, from a first information processing apparatus connected with said network, circuit data indicating characteristics of an electronic circuit through said network;
carrying out operational simulation of said electronic circuit using said circuit models and said circuit data; and
sending results of said operational simulation through said network.

10. A computer program product as claimed in claim 9,
wherein, at said step of sending results of said operational simulation, said results of said operational simulation are sent to said first information processing apparatus from said second information processing apparatus through said network.

11. A computer program product as claimed in claim 9,
wherein each of said circuit models includes device models, each indicating operations of a device constituting a circuit.

12. A computer program product as claimed in claim 11,
wherein each of said device models includes transistor models, each indicating operations of a transistor constituting said circuit.
